(19) United States
(12) Patent Application Publication
(10) Pub. No.: US 2026/0214179 A1
(43) Pub. Date: Jul. 23, 2026

(54) PRINTING APPARATUS AND CONTROL METHOD

(71) Applicant: SEIKO EPSON CORPORATION, TOKYO (JP)

(72) Inventors: Saeful AZHAR, Garut (ID); Riko Firma HADI, Pesisir Selatan (ID)

(21) Appl. No.: 19/453,028

(22) Filed: Jan. 20, 2026

(30) Foreign Application Priority Data
Jan. 20, 2025 (JP) 2025-007568

(51) Int. Cl. H04N 1/60; B41J 3/44; B41J 29/387; B41J 29/393; B41J 29/46; H04N 1/00

(52) U.S. Cl. CPC H04N 1/6055; B41J 3/44; B41J 29/387; B41J 29/393; B41J 29/46; H04N 1/00408; H04N 1/00824

(57) ABSTRACT

A printing apparatus includes: a printing unit; a body case; a scanner unit that includes an image reading sensor for reading a document and that is pivotable between a closed state in which the body case is closed and an open state in which the body case is opened; and a control unit, in which the scanner unit includes a reading reference member that includes a first portion having a first color and a second portion having a second color and that has a facing position facing the image reading sensor different between when the scanner unit is in the open state and when the scanner unit is in the closed state, and the control unit detects the open state of the scanner unit or the closed state of the scanner unit with respect to the body case based on a reading result of the reading reference member by the image reading sensor.

The present application is based on, and claims priority from JP Application Serial Number 2025-007568, filed Jan. 20, 2025, the disclosure of which is hereby incorporated by reference herein in its entirety.

### BACKGROUND

### 1. Technical Field

The present disclosure relates to a printing apparatus and a control method.

### 2. Related Art

There is an image forming apparatus provided with an opening and closing portion that can be opened and closed with respect to an apparatus main body. An image forming apparatus described in JP-A-2007-10949 includes a printer unit that is an apparatus main body and a scanner unit that can be opened and closed with respect to the printer unit. The printer unit includes an open/close sensor that detects an open/closed state of the scanner unit. The open/close sensor is an optical sensor. The open/close sensor detects the open/closed state of the scanner unit by detecting a detector protruding from a bottom surface of the scanner unit with a photointerrupter.

JP-A-2007-10949 is an example of the related art.

It is difficult to reduce the number of components by providing the open/close sensor that detects opening and closing of the scanner unit.

### SUMMARY

A printing apparatus according to the present disclosure includes: a printing unit configured to perform printing on a medium; a body case accommodating the printing unit; a scanner unit that includes an image reading sensor for reading a document and that is pivotable between a closed state in which the body case is closed and an open state in which the body case is opened; and a control unit configured to control the printing unit and the image reading sensor. The scanner unit includes a reading reference member that includes a first portion having a first color and a second portion having a second color different from the first color and that has a facing position facing the image reading sensor different between when the scanner unit is in the open state and when the scanner unit is in the closed state, and the control unit detects the open state of the scanner unit or the closed state of the scanner unit with respect to the body case based on a reading result of the reading reference member by the image reading sensor.

A control method according to the present disclosure is a control method for a printing apparatus including a body case accommodating a printing unit that performs printing on a medium, and a scanner unit that includes a reading reference member and an image reading sensor and that is pivotable between a closed state in which the body case is closed and an open state in which the body case is opened, the reading reference member including a first portion having a first color and a second portion having a second color different from the first color. The control method includes: receiving a printing instruction for instructing the printing on the medium; starting the printing on the medium; and monitoring whether the scanner unit is in the open state with respect to the body case based on a reading result of the reading reference member by the image reading sensor when the printing is performed.

### BRIEF DESCRIPTION OF THE DRAWINGS

FIG. 1 is a diagram illustrating an external configuration of a multifunction peripheral.

FIG. 2 is a diagram illustrating an external configuration of the multifunction peripheral.

FIG. 3 is a diagram illustrating an external configuration of the multifunction peripheral.

FIG. 4 is a diagram illustrating an external configuration of a scanner housing.

FIG. 5 is a diagram illustrating an external configuration of an ADF support housing.

FIG. 6 is a diagram illustrating a schematic configuration of the scanner housing.

FIG. 7 is a diagram illustrating a schematic configuration of the scanner housing.

FIG. 8 is a diagram illustrating a schematic configuration of the scanner housing.

FIG. 9 is a diagram illustrating a schematic configuration of the scanner housing.

FIG. 10 is a diagram schematically illustrating electric signals converted by a substrate.

FIG. 11 is a diagram illustrating an example of a detection pattern output from a second sensor module.

FIG. 12 is a diagram illustrating an example of a detection pattern output from the second sensor module.

FIG. 13 is a diagram illustrating a schematic configuration of the scanner housing.

FIG. 14 is a diagram illustrating a schematic configuration of a detected portion.

FIG. 15 is a diagram illustrating a schematic configuration of a flap.

FIG. 16 is a diagram illustrating a state of the detected portion.

FIG. 17 is a diagram illustrating a relationship between a state of the flap and a detection pattern.

FIG. 18 is a diagram illustrating a state of the detected portion.

FIG. 19 is a diagram illustrating a relationship between a state of the flap and a detection pattern.

FIG. 20 is a diagram illustrating a schematic configuration of the multifunction peripheral.

FIG. 21 is a block diagram illustrating the multifunction peripheral.

FIG. 22 is a diagram illustrating a control flow executed in the multifunction peripheral.

FIG. 23 is a diagram illustrating a display example displayed on a display panel.

FIG. 24 is a diagram illustrating a schematic configuration of a flap.

FIG. 25 is a diagram illustrating a schematic configuration of a flap.

FIG. 26 illustrates a schematic configuration of a flap.

FIG. 27 is a diagram illustrating a schematic configuration of a flap.

FIG. 28 is a diagram illustrating a schematic configuration of a flap.

### DESCRIPTION OF EMBODIMENTS

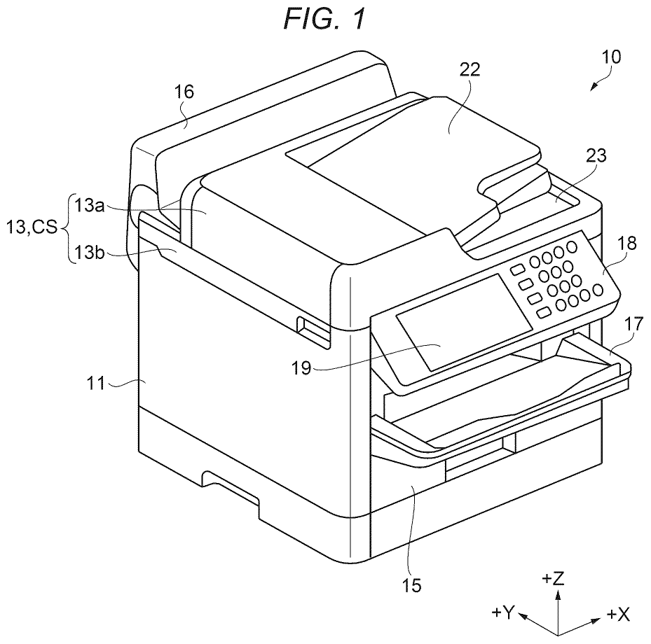

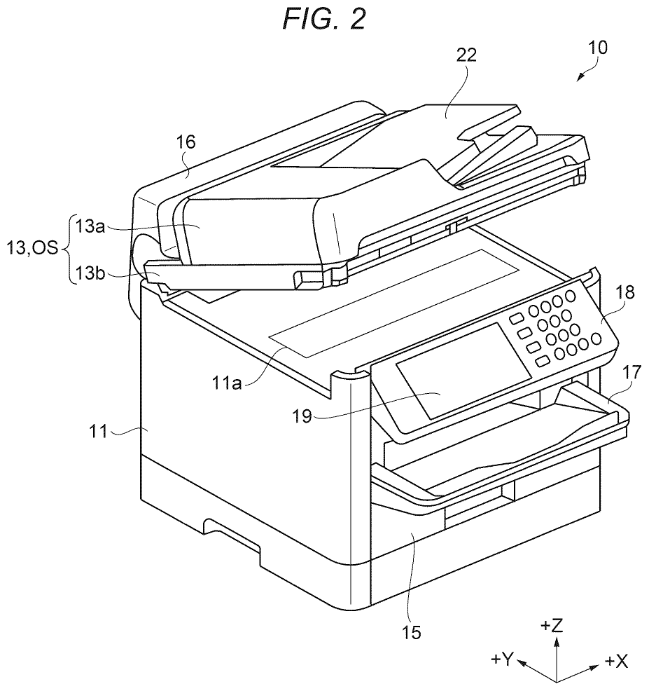

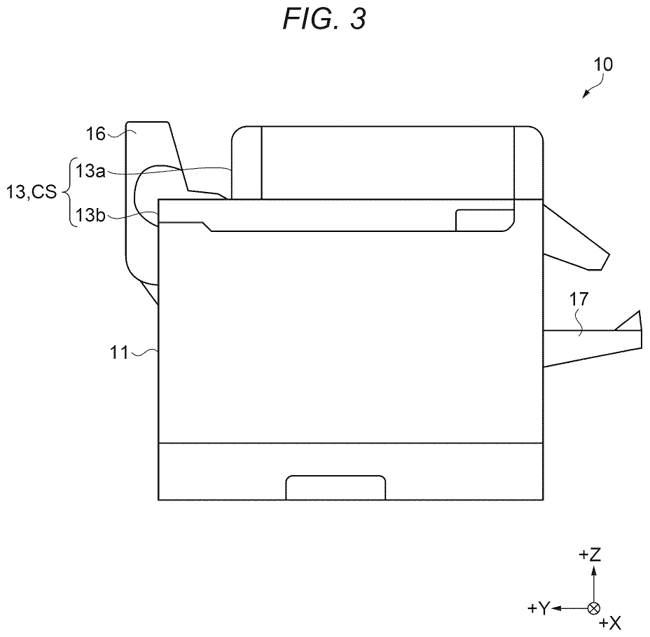

FIGS. 1, 2, and 3 illustrate an external configuration of a multifunction peripheral 10. The multifunction peripheral 10 has a reading function of reading a document D and a print function of performing printing on a medium M. The multifunction peripheral 10 corresponds to an example of a printing apparatus. FIGS. 1 and 2 are perspective views of the multifunction peripheral 10. FIG. 3 illustrates an external configuration of a side surface of the multifunction peripheral 10 coupled to a front surface of the multifunction peripheral 10. The front surface of the multifunction peripheral 10 is a surface on which a control panel 18 described later is provided.

Multiple drawings including FIG. 1 illustrate an XYZ coordinate system. A Z axis is an axis orthogonal to an installation surface of the multifunction peripheral 10. A +Z direction is a direction upward from the installation surface. A −Z direction is a direction from above toward the installation surface. An X axis is an axis orthogonal to the Z axis. A +X direction is a direction from left to right of the front surface of the multifunction peripheral 10. A −X direction is a direction from right to left of the front surface of the multifunction peripheral 10. A Y axis is an axis orthogonal to the X axis and the Z axis. A +Y direction is a direction from the front surface toward a rear of the multifunction peripheral 10. A −Y direction is a direction from the rear toward the front surface of the multifunction peripheral 10.

The multifunction peripheral 10 illustrated in FIGS. 1, 2, and 3 includes a printer housing 11, a scanner housing 13, a paper feed cassette 15, a paper feed tray 16, a medium discharge tray 17, and the control panel 18.

The printer housing 11 accommodates a printing mechanism 50 described later. The printer housing 11 corresponds to an example of a body case. The printer housing 11 pivotably supports the scanner housing 13. The printer housing 11 supports the paper feed cassette 15 so that the paper feed cassette 15 can be inserted and removed. The printer housing 11 is provided with the paper feed tray 16, the medium discharge tray 17, and the control panel 18.

The scanner housing 13 accommodates a reading mechanism 20 described later. The scanner housing 13 corresponds to an example of a scanner unit. The scanner housing 13 is pivotably supported by the printer housing 11 around a scanner housing pivoting shaft (not illustrated). The scanner housing pivoting shaft is a shaft parallel or substantially parallel to the X axis. The scanner housing 13 pivots between a shielded state CS illustrated in FIG. 1 and an open state OS illustrated in FIG. 2 by pivoting with respect to the printer housing 11.

FIG. 1 illustrates the scanner housing 13 in the shielded state CS. The shielded state CS is a state in which the scanner housing 13 closes the printer housing 11. In the shielded state CS, a user of the multifunction peripheral 10 cannot access an inside of the printer housing 11. The shielded state CS corresponds to an example of a closed state.

FIG. 2 illustrates the scanner housing 13 in the open state OS. The open state OS is a state in which the scanner housing 13 opens the printer housing 11. In the open state OS, the user can access the inside of the printer housing 11. The open state OS corresponds to an example of an open state. As illustrated in FIG. 2, a printer housing opening 11a is provided in a +Z direction surface of the printer housing 11. The user can access the inside of the printer housing 11 through the printer housing opening 11a. When the scanner housing 13 is in the open state OS, the user can take out the medium M inside the printer housing 11, access a carriage 53 described later, and the like.

The scanner housing 13 includes an ADF housing 13a and an ADF support housing 13b. The ADF is an abbreviation for Automatic Document Feeder.

The ADF housing 13a accommodates a part of the reading mechanism 20. The ADF housing 13a corresponds to an example of a housing member. The ADF housing 13a accommodates a document conveyance mechanism 21 described later. The document conveyance mechanism 21 is in the reading mechanism 20. The ADF housing 13a is disposed at a position in a +Z direction of the ADF support housing 13b. The ADF housing 13a is pivotable about an ADF housing pivoting shaft parallel or substantially parallel to the X axis with respect to the ADF support housing 13b. The ADF housing 13a includes a document placement portion 22 and a document discharge portion 23.

The document placement portion 22 places one or more documents D. The document placement portion 22 is provided at a +Z direction surface of the ADF housing 13a. The document D placed on the document placement portion 22 is conveyed toward the document discharge portion 23 by the document conveyance mechanism 21.

The document D conveyed by the document conveyance mechanism 21 is placed on the document discharge portion 23. The document D read by a first sensor module 31 or the like described later is placed on the document discharge portion 23. The document discharge portion 23 is provided at a position in the −Z direction of the document placement portion 22.

The ADF support housing 13b accommodates a part of the reading mechanism 20. The ADF support housing 13b pivotably supports the ADF housing 13a. The ADF support housing 13b is provided at a position in a −Z direction of the ADF housing 13a and at a position in the +Z direction of the printer housing 11.

The paper feed cassette 15 accommodates one or more media M. The paper feed cassette 15 is insertable into and removable from the printer housing 11 along the Y axis. The paper feed cassette 15 is provided at a position in a −Z direction in the printer housing 11.

The paper feed tray 16 supports the medium M conveyed to the printing mechanism 50. The paper feed tray 16 supports one or more media M. As illustrated in FIG. 3, the paper feed tray 16 is provided at a position in the +Z direction at a position in a +Y direction of the printer housing 11.

The medium M printed by the printing mechanism 50 is placed on the medium discharge tray 17. The medium discharge tray 17 is provided on the front surface of the multifunction peripheral 10. The medium discharge tray 17 is provided at a position in a +Z direction of the paper feed cassette 15. The medium discharge tray 17 may include a support member that supports the medium M. The support member is extendable in the −Y direction, for example.

The control panel 18 receives an input operation by the user. The control panel 18 includes input buttons for receiving the input operation. The control panel 18 includes a display panel 19. The control panel 18 is provided at a −Y direction surface of the multifunction peripheral 10.

The display panel 19 displays various information. The display panel 19 displays an operation screen for displaying various icons, message information, and the like. The display panel 19 may have a touch input function. When the display panel 19 has a touch input function, an input operation by the user is received. The display panel 19 includes a liquid crystal display, an organic electro luminescence (EL) display, or the like.

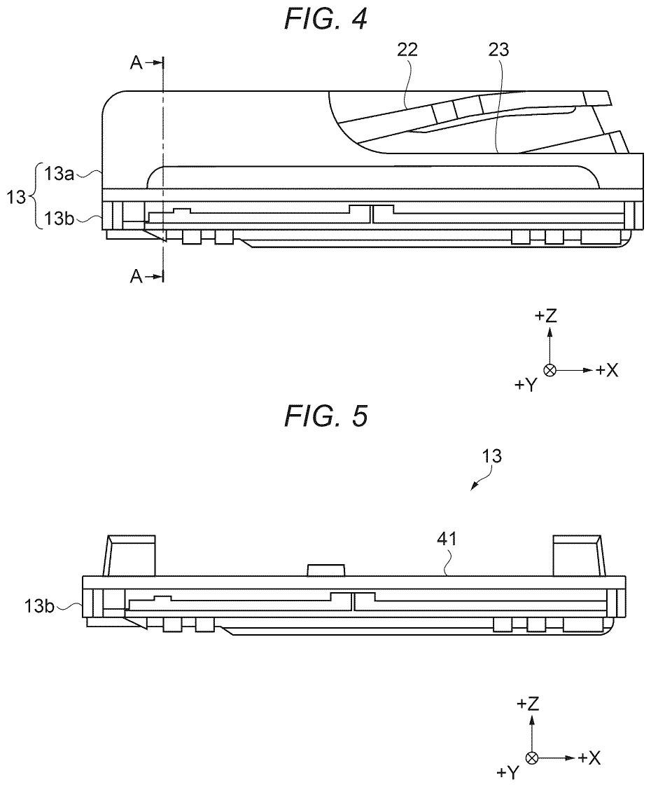

FIG. 4 illustrates an external configuration of the scanner housing 13. FIG. 4 illustrates the external configuration of the scanner housing 13 in a plan view from the −Y direction. FIG. 4 illustrates the ADF housing 13a at a shielding position for shielding a document table 41 provided in the ADF support housing 13b.

FIG. 5 illustrates an external configuration of the ADF support housing 13b. FIG. 5 illustrates the ADF support housing 13b in a plan view from the −Y direction. The ADF support housing 13b includes the document table 41. The document table 41 is provided at a +Z direction surface of the ADF support housing 13b. The user can place the document D on the document table 41.

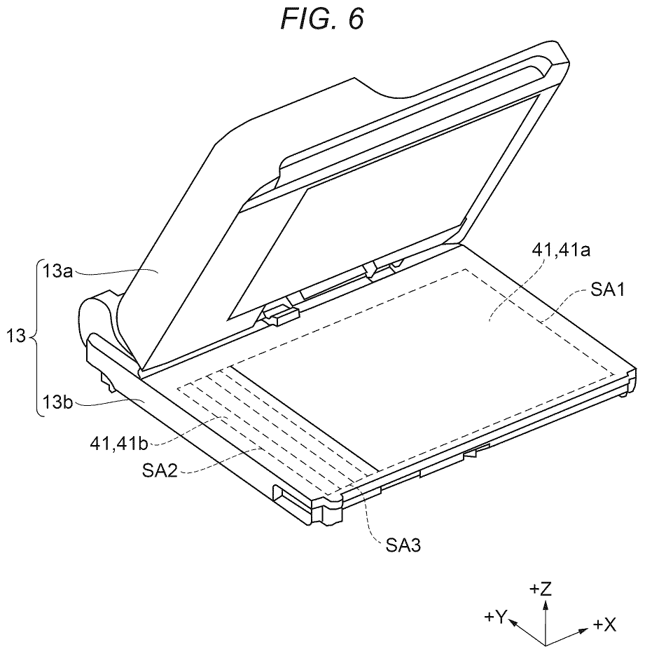

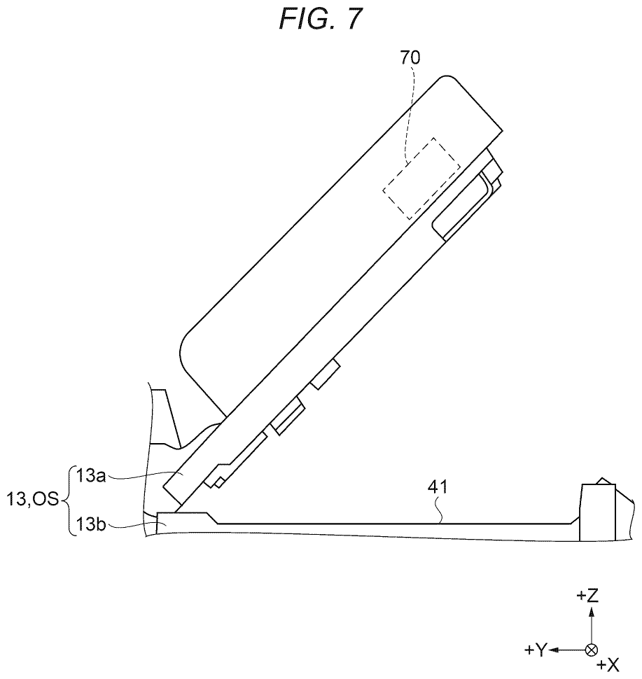

FIGS. 6 and 7 illustrate a schematic configuration of the scanner housing 13. FIGS. 6 and 7 illustrate the scanner housing 13 in a state where the ADF housing 13a is pivoted to an open position by the user. The open position is a position where the user can place the document D on the document table 41 by opening the document table 41. FIG. 6 is a perspective view of the scanner housing 13 viewed from a front. FIG. 7 illustrates the scanner housing 13 in a plan view from the −X direction. FIG. 6 illustrates the document table 41. FIG. 7 virtually illustrates a detected portion 70.

The document D to be read by a second sensor module 35 described later is placed on the document table 41. The document table 41 is supported by the ADF support housing 13b. The document table 41 includes a first glass 41a and a second glass 41b. The document table 41 is divided into a first reading area SA1, a second reading area SA2, and a third reading area SA3.

The first glass 41a supports the document D placed by the user. The first glass 41a is a light transmissive material that transmits light emitted from the second sensor module 35 described later.

The second glass 41b supports the document D conveyed by the document conveyance mechanism 21 accommodated in the ADF housing 13a. The second glass 41b is a light transmissive material that transmits light emitted from the second sensor module 35. The second glass 41b is disposed at a position in a −X direction of the first glass 41a. The second glass 41b corresponds to an example of a light transmissive member.

The first reading area SA1 is an area for reading the document D placed on the first glass 41a by the user. In the first reading area SA1, the second sensor module 35 moves along the X axis. The second sensor module 35 moving along the X axis reads the document D placed on the first glass 41a in the first reading area SA1.

The second reading area SA2 is an area for reading the document D conveyed onto the second glass 41b by the document conveyance mechanism 21. In the second reading area SA2, the second sensor module 35 stops at a position in a −Z direction of the second glass 41b. The second sensor module 35 in the stopped state reads the document D supported by the second glass 41b in the second reading area SA2.

The third reading area SA3 is an area between the first reading area SA1 and the second reading area SA2 along the X axis. The second sensor module 35 stops at a home position HP when the reading mechanism 20 is in a stopped state or an idling state. The third reading area SA3 is an area facing the second sensor module 35 at the home position HP.

The detected portion 70 is accommodated in the ADF housing 13a. The detected portion 70 is a portion detected by the second sensor module 35. The detected portion 70 is disposed at a position in the −Y direction in the ADF housing 13a. The detected portion 70 is disposed at a free end side of the ADF housing 13a.

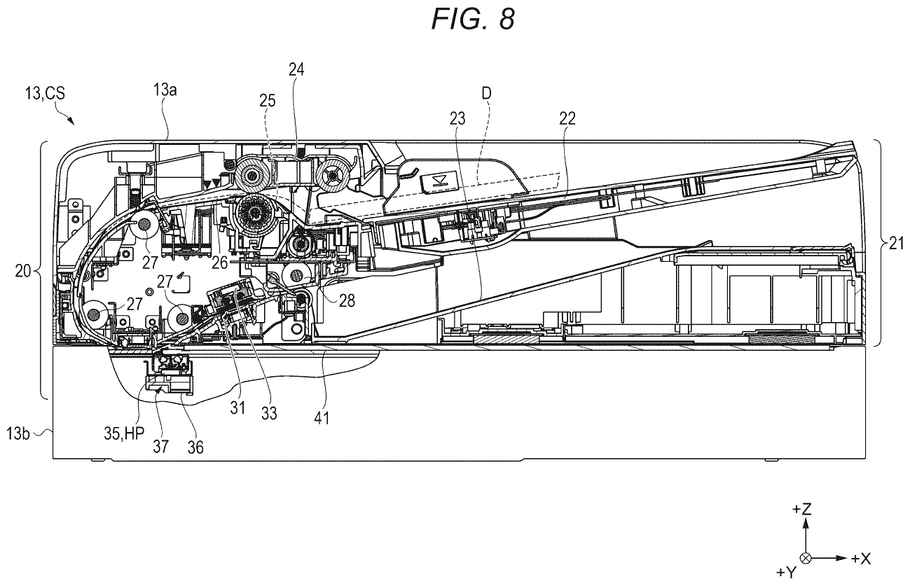

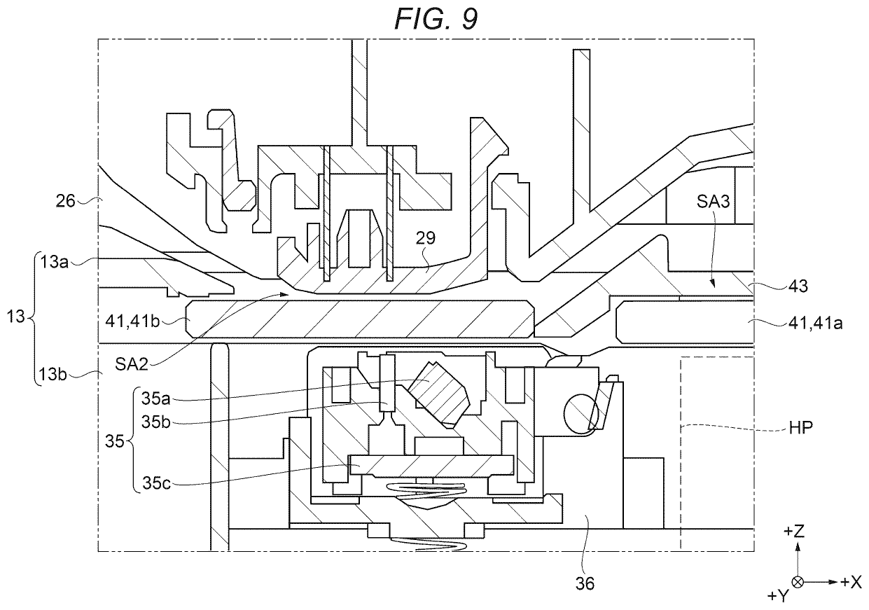

FIG. 8 illustrates a schematic configuration of the scanner housing 13. FIG. 8 illustrates a cross-sectional configuration of the reading mechanism 20 accommodated in the scanner housing 13 in a cross-sectional view from the −Y direction. FIG. 8 illustrates the scanner housing 13 in the shielded state CS. In FIG. 8, the document D placed on the document placement portion 22 is indicated by a broken line.

The reading mechanism 20 is accommodated in the scanner housing 13. The reading mechanism 20 reads the document D and generates read data. The reading mechanism 20 includes the document conveyance mechanism 21, the first sensor module 31, and the second sensor module 35. The document conveyance mechanism 21 and the first sensor module 31 are accommodated in the ADF housing 13a. The second sensor module 35 is accommodated in the ADF support housing 13b.

The document conveyance mechanism 21 conveys the document D placed on the document placement portion 22 toward the document discharge portion 23. The document conveyance mechanism 21 includes a feeding unit 24, a document conveyance path 26, a plurality of document conveyance rollers 27, and a document discharge roller pair 28.

The feeding unit 24 separates the documents D one by one from the plurality of documents D stacked on the document placement portion 22 and feeds the documents D toward the document discharge portion 23. The feeding unit 24 includes a retard roller 25 that separates the stacked documents D.

The document conveyance path 26 is a path through which the document D passes inside the ADF housing 13a. The document conveyance path 26 corresponds to an example of a conveyance path. A plurality of document conveyance rollers 27, the first sensor module 31, and the second sensor module 35 are disposed along the document conveyance path 26. The document D is conveyed toward the first sensor module 31 and the second sensor module 35 along the document conveyance path 26. The document D read by the first sensor module 31 or the like is conveyed to the document discharge portion 23 along the document conveyance path 26.

The plurality of document conveyance rollers 27 conveys the document D along the document conveyance path 26. The document conveyance roller 27 corresponds to an example of a conveyance roller. The document conveyance roller 27 conveys the document D fed by the feeding unit 24 toward the first sensor module 31 and the second sensor module 35. The document conveyance roller 27 conveys the document D read by the first sensor module 31 or the like toward the document discharge portion 23.

The document discharge roller pair 28 discharges the document D conveyed in the document conveyance path 26 to the document discharge portion 23. The document D discharged by the document discharge roller pair 28 is placed on the document discharge portion 23.

The first sensor module 31 reads a first surface of the document D conveyed in the document conveyance path 26 from a position in the +Z direction. The first sensor module 31 is implemented with a contact image sensor module (CISM) as an example. The first sensor module 31 may have the same configuration as or a different configuration from the second sensor module 35. As an example, the configuration of the first sensor module 31 is the same as the configuration of the second sensor module 35 described later. The first sensor module 31 is pressed by a first elastic member 33.

The first elastic member 33 presses the first sensor module 31 toward the document conveyance path 26. The first elastic member 33 presses the first sensor module 31 against the document conveyance path 26 and holds the first sensor module 31 at a predetermined position. By the pressing of the first elastic member 33, a distance between the first sensor module 31 and the document D conveyed in the document conveyance path 26 becomes a predetermined distance.

The second sensor module 35 reads a second surface of the document D conveyed in the document conveyance path 26 via the document table 41 from a position in the −Z direction. The second surface of the document D is an opposite surface of the first surface of the document D. The second sensor module 35 reads −Z direction surface of the document D placed on the document table 41 by the user from the position in the −Z direction. The second sensor module 35 is implemented with an CISM as an example. The second sensor module 35 corresponds to an example of an image reading sensor. The configuration of the second sensor module 35 will be described later. FIG. 8 illustrates the second sensor module 35 at the home position HP. The second sensor module 35 is supported by a sensor carriage 36. The second sensor module 35 is pressed by a second elastic member 37.

The sensor carriage 36 movably supports the second sensor module 35. The sensor carriage 36 moves the second sensor module 35 along the X axis. The sensor carriage 36 moves the second sensor module 35 to any of the first reading area SA1, the second reading area SA2, and the third reading area SA3. The sensor carriage 36 moves the second sensor module 35 in the first reading area SA1. When the sensor carriage 36 moves the second sensor module 35 in the first reading area SA1, the second sensor module 35 reads the document D placed on the document table 41 by the user.

The second elastic member 37 is supported by the sensor carriage 36. The second elastic member 37 presses the second sensor module 35 against the document table 41. The second elastic member 37 presses the second sensor module 35 against the document table 41 and holds the second sensor module 35 at a predetermined position. By the pressing of the second elastic member 37, a distance between the second sensor module 35 and the document D becomes a predetermined distance.

FIG. 9 illustrates a schematic configuration of the scanner housing 13. FIG. 9 illustrates an enlarged part of a cross-sectional configuration of the scanner housing 13 illustrated in FIG. 8. FIG. 9 illustrates a vicinity of the second sensor module 35 in an enlarged manner. In FIG. 9, the home position HP of the second sensor module 35 is indicated by a broken line. FIG. 9 illustrates a pressing plate 29 and a guide member 43.

FIG. 9 illustrates the schematic configuration when the second sensor module 35 is located in the second reading area SA2. The second sensor module 35 is located at a position illustrated in FIG. 9 when reading the document D conveyed by the document conveyance mechanism 21. When located in the second reading area SA2, the second sensor module 35 faces the pressing plate 29 via the second glass 41b.

The pressing plate 29 presses the document D conveyed in the document conveyance path 26. The pressing plate 29 is provided in the ADF housing 13a. The pressing plate 29 faces the second glass 41b when the ADF housing 13a is at the shielding position. The pressing plate 29 is disposed at a position in a +Z direction of the second glass 41b when the ADF housing 13a is at the shielding position. The second sensor module 35 reads the document D sandwiched between the pressing plate 29 and the second glass 41b. The pressing plate 29 is implemented with a member of a predetermined color set in advance.

The guide member 43 is provided at a position in a +X direction of the second glass 41b and in a +Z direction of the first glass 41a. A −Z direction surface of the guide member 43 faces the second sensor module 35 located at the home position HP. The guide member 43 is provided in the ADF housing 13a. The guide member 43 guides the document D read by the second sensor module 35 toward the document discharge roller pair 28.

FIG. 9 illustrates a configuration of the second sensor module 35. The second sensor module 35 includes a light emitting diode (LED) array 35a, a lens array 35b, and a substrate 35c.

The LED array 35a includes a plurality of LEDs as light sources. The plurality of LEDs emit red light R, green light G, and blue light B, respectively. The LED array 35a irradiates the document D with each color light. The LED array 35a irradiates the document D supported by the second glass 41b or a facing member facing the LED array 35a with each color light. The facing members are the pressing plate 29, the guide member 43, and the like.

The lens array 35b includes a plurality of lenses as light collectors. The lens array 35b is implemented with, for example, a rod lens array. The lens array 35b collects color light emitted by the LED array 35a and reflected by the document D or the like. The color light collected by the lens array 35b is received by the substrate 35c.

The substrate 35c is equipped with a plurality of sensors as photoelectric conversion elements. The plurality of sensors are disposed at the substrate 35c along the Y axis. The plurality of sensors disposed at the substrate 35c receive each color light reflected by the document D or the facing member via the lens array 35b, and convert the received color light into an electric signal.

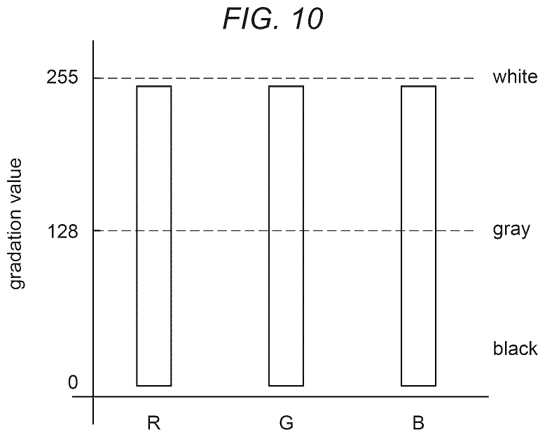

FIG. 10 schematically illustrates electric signals converted by the substrate 35c. The substrate 35c outputs the red light R, the green light G, and the blue light B received by the substrate 35c with a gradation value. The red light R, the green light G, and the blue light B are scaled in units of 0 to 255. When the gradation value of each of the red light R, the green light G, and the blue light B is 255, a color of an object to be detected is white. When the gradation value of each of the red light R, the green light G, and the blue light B is 0, a color of an object to be detected is black. Alternatively, when the gradation value of each of the red light R, the green light G, and the blue light B is 0, the substrate 35c does not detect light.

The second sensor module 35 irradiates the facing member with each color light and detects each color light reflected by the facing member by the substrate 35c. The second sensor module 35 outputs a detection pattern of electric signals output from the plurality of sensors disposed along the Y axis to a control unit 100 described later. The control unit 100 can detect a stop position of the second sensor module 35 by analyzing the detection pattern.

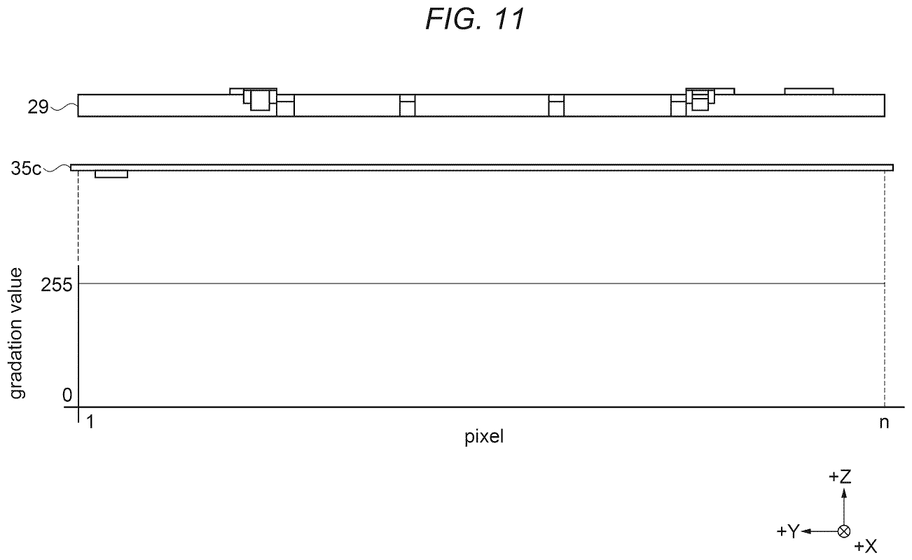

FIG. 11 illustrates an example of a detection pattern output from the second sensor module 35. FIG. 11 illustrates a positional relationship between the pressing plate 29 and the substrate 35c. FIG. 11 illustrates an output result of each of the plurality of sensors disposed on the substrate 35c along the Y axis. FIG. 11 illustrates the output result output when the second sensor module 35 is stopped at a position facing the pressing plate 29. The output result is a gradation value of each sensor detected on the substrate 35c when the LED array 35a irradiates the pressing plate 29 with each color light.

FIG. 11 illustrates a detection result of the pressing plate 29 formed of a white member as an example. When the pressing plate 29 is formed of the white member, the second sensor module 35 outputs a detection pattern having a uniform gradation value of 255.

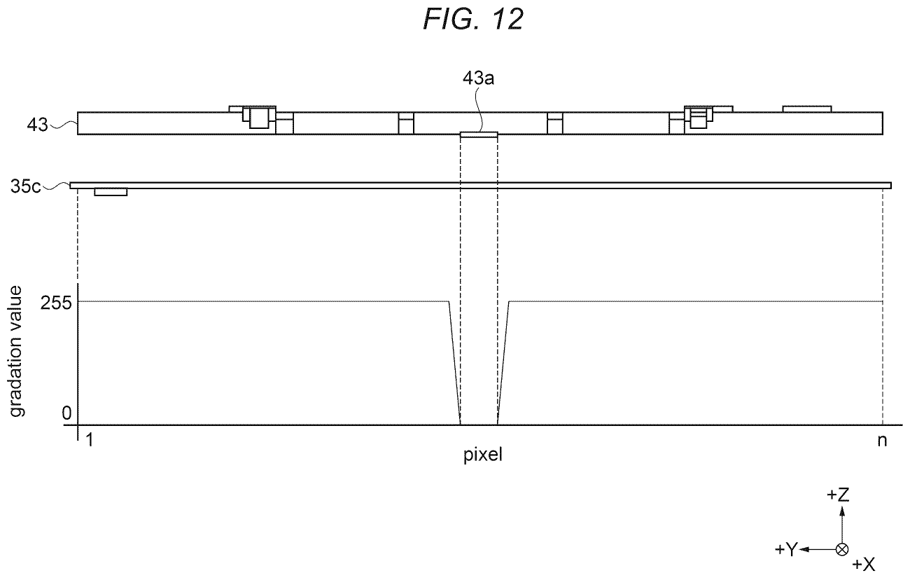

FIG. 12 illustrates an example of a detection pattern output from the second sensor module 35. FIG. 12 illustrates a positional relationship between the guide member 43 and the substrate 35c. FIG. 12 illustrates an output result of each of the plurality of sensors disposed on the substrate 35c along the Y axis. FIG. 12 illustrates an output result output when the second sensor module 35 is stopped at the home position HP. The output result is a gradation value of each sensor detected on the substrate 35c when the LED array 35a irradiates the guide member 43 with light.

FIG. 12 illustrates, as an example, a detection result of the guide member 43 formed of a white member with a mark member 43a given to a part of the guide member 43. The mark member 43a illustrated in FIG. 12 is made of a black material. A gradation value of each color light reflected by the mark member 43 a given to the guide member 43 is 0. A gradation value of each color light in a portion where the mark member 43a is not provided is 255. When the guide member 43 is implemented with the guide member 43 having the mark member 43a, the second sensor module 35 outputs the detection pattern illustrated in FIG. 12.

The control unit 100 receives the detection pattern illustrated in FIG. 11 or 12 from the second sensor module 35. The control unit 100 can determine a position of the second sensor module 35 based on the received detection pattern. When the detection pattern illustrated in FIG. 11 is received, the control unit 100 determines that the second sensor module 35 is stopped at a position facing the second glass 41b. When the detection pattern illustrated in FIG. 12 is received, the control unit 100 determines that the second sensor module 35 is stopped at the home position HP.

The pressing plate 29 illustrated in FIG. 11 and the guide member 43 illustrated in FIG. 12 are formed of white members, but are not limited thereto. A detection pattern of the pressing plate 29 may be different from a detection pattern of the guide member 43. A color of the pressing plate 29 and a color of the guide member 43 are appropriately set.

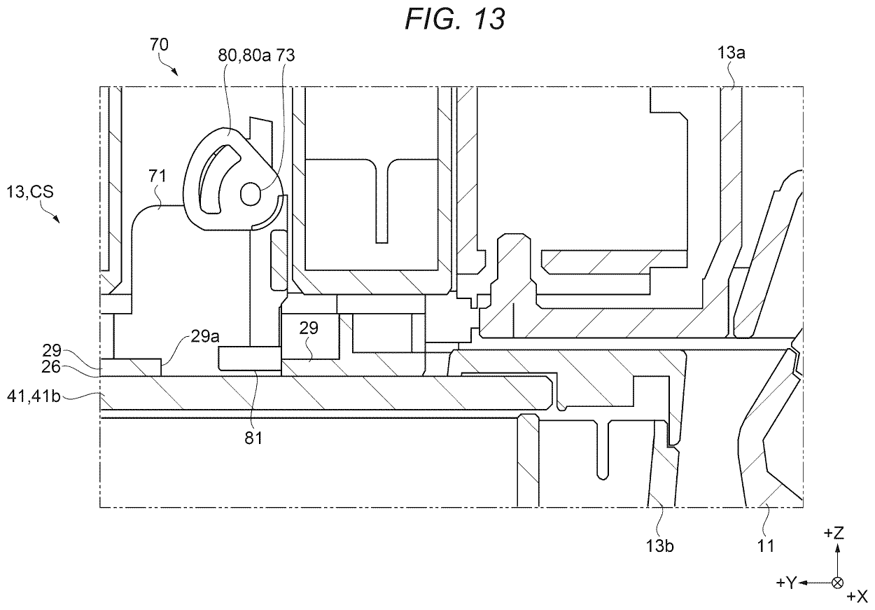

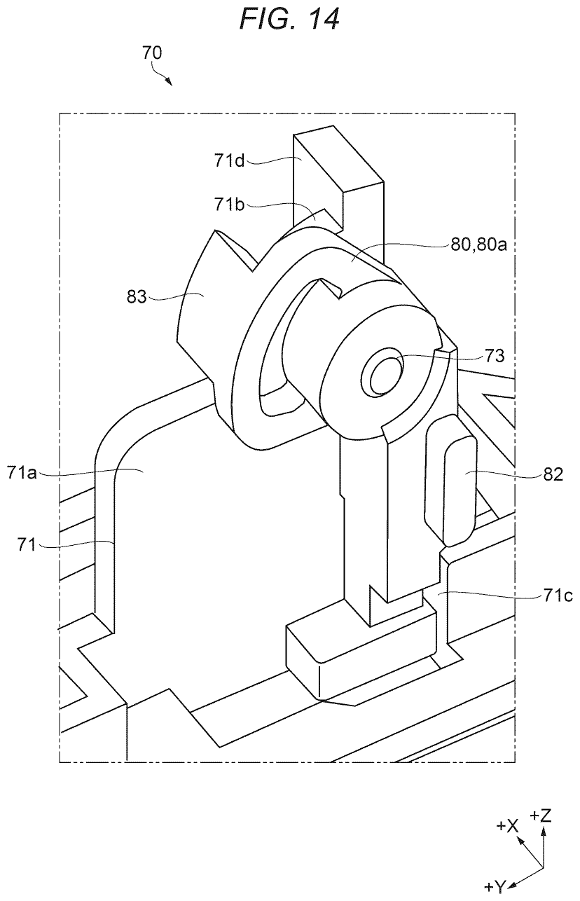

FIG. 13 illustrates a schematic configuration of the scanner housing 13. FIG. 13 illustrates an enlarged part of an A-A cross section illustrated in FIG. 4. FIG. 13 illustrates a part of the scanner housing 13 in the shielded state CS in a cross-sectional view from the −X direction. FIG. 13 illustrates a vicinity of the detected portion 70 in an enlarged manner. FIG. 13 illustrates the pressing plate 29, the second glass 41b, and the detected portion 70.

The detected portion 70 is detected by the second sensor module 35. The detected portion 70 is provided at a position facing the second sensor module 35. The detected portion 70 is provided at a position in a +Z direction of the second glass 41b and the pressing plate 29. The detected portion 70 faces the second glass 41b across the document conveyance path 26. The detected portion 70 includes a press plate 71, a shaft 73, and a flap 80. The detected portion 70 is accommodated in the ADF housing 13a.

The press plate 71 pivotably supports the flap 80 via the shaft 73. The press plate 71 is supported by the ADF housing 13a or the pressing plate 29. A −Z direction surface of the press plate 71 may be readable by the second sensor module 35.

The shaft 73 is a pivoting shaft that pivots the flap 80. The shaft 73 supports the flap 80. The shaft 73 extends along the X axis.

The flap 80 is provided pivotably about the shaft 73. The flap 80 pivots according to the pivoting of the scanner housing 13. The flap 80 corresponds to an example of a reading reference member. The flap 80 is provided at a facing position facing the second sensor module 35. The flap 80 faces the second glass 41b across the document conveyance path 26. FIG. 13 illustrates a first flap 80a which is an example of the flap 80. The flap 80 has a lower surface 81.

The lower surface 81 is a surface facing the second sensor module 35 when the scanner housing 13 is in the shielded state CS. The lower surface 81 corresponds to an example of a first portion. The lower surface 81 reflects each color light emitted from the LED array 35a of the second sensor module 35 and causes the substrate 35c to detect each reflected color light. The lower surface 81 is formed in a first color. The first color is a color having any one of a predetermined hue, a predetermined brightness, and a predetermined saturation.

The pressing plate 29 is provided with a pressing plate opening 29a. The pressing plate opening 29a is provided at a position in a −Z direction of the detected portion 70. By providing the pressing plate opening 29a, the color light emitted by the LED array 35a is reflected by the press plate 71 or the flap 80 and detected by the substrate 35c.

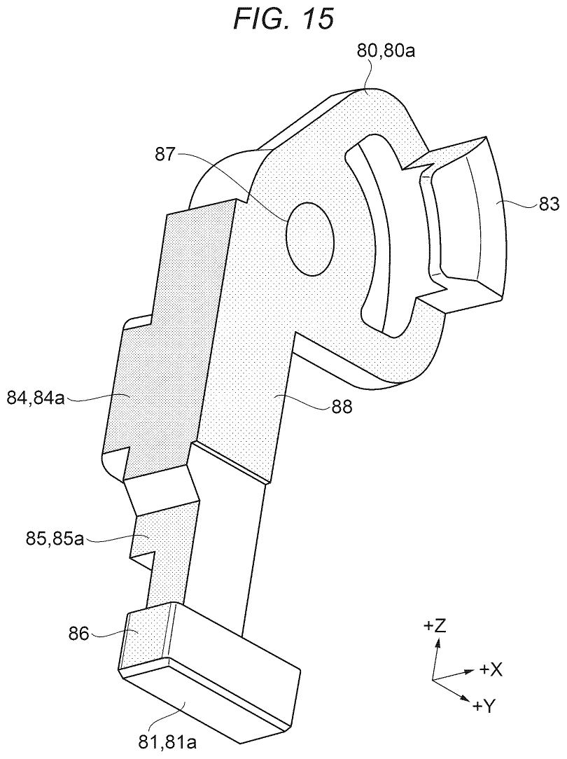

FIG. 14 illustrates a schematic configuration of the detected portion 70. FIG. 14 is a perspective view illustrating the detected portion 70 provided in the scanner housing 13 in the shielded state CS. FIG. 14 illustrates the detected portion 70 when the flap 80 does not pivot.

The press plate 71 includes a wall portion 71a, a curved surface portion 71b, a first locking portion 71c, and a second locking portion 71d. The wall portion 71a is a surface facing the flap 80. The curved surface portion 71b is a surface facing a part of the flap 80. The first locking portion 71c and the second locking portion 71d are surfaces that restrict pivoting of the flap 80.

The flap 80 includes a balancer 82 and a hook 83. The balancer 82 adjusts a pivoting speed of the flap 80. A shape and weight of the balancer 82 are appropriately set according to the pivoting speed of the flap 80. The hook 83 engages with the press plate 71. The hook 83 restricts a position of the flap 80 along the X axis. An end surface of the hook 83 is configured to abut against the second locking portion 71d. Since the end surface of the hook 83 abuts against the second locking portion 71d, excessive pivoting of the flap 80 is prevented.

FIG. 15 illustrates a schematic configuration of the flap 80. FIG. 15 is a perspective view illustrating the flap 80. FIG. 15 illustrates a configuration of a first flap 80a which is an example of the flap 80. The flap 80 has the lower surface 81, the hook 83, a side surface 84, an intermediate surface 85, an abutment surface 86, a through hole 87, and a wall surface 88.

The first flap 80a has a first lower surface 81a, which is an example of the lower surface 81. The first lower surface 81a is formed in white, for example. White is an example of the first color.

The side surface 84 is a surface facing the second sensor module 35 when the scanner housing 13 is in the open state OS. The side surface 84 corresponds to an example of a second portion. The side surface 84 reflects the color light emitted from the LED array 35a of the second sensor module 35 and causes the substrate 35c to detect each reflected color light. The side surface 84 is formed in a second color different from the first color. The second color is a color that differs in at least one of the hue of the first color, the brightness of the first color, and the saturation of the first color.

The first flap 80a has a first side surface 84a, which is an example of the side surface 84. The first side surface 84a is formed in a color different from that of the first lower surface 81a. The first side surface 84a is formed in black, for example. Black is an example of the second color.

The intermediate surface 85 is a surface facing the second sensor module 35 when the scanner housing 13 transitions between the shielded state CS and the open state OS. The intermediate surface 85 reflects the color light emitted from the LED array 35a and causes the substrate 35c to detect each reflected color light. For example, the intermediate surface 85 is formed in a third color different from the first color and the second color.

The first flap 80a has a first intermediate surface 85a, which is an example of the intermediate surface 85. The first intermediate surface 85a is formed in a color different from that of the first lower surface 81a and the first side surface 84a. The first intermediate surface 85a is formed in gray, for example. Gray is an example of the third color.

The abutment surface 86 abuts against the first locking portion 71c of the press plate 71 when the scanner housing 13 is in the shielded state CS. When the abutment surface 86 abuts against the first locking portion 71c, the flap 80 is prevented from excessively pivoting in the −Y direction. When the abutment surface 86 abuts against the first locking portion 71c, the lower surface 81 stops at a position facing the second sensor module 35.

The through hole 87 is a shaft hole that supports the shaft 73. The through hole 87 is formed along the X axis.

The wall surface 88 is a surface facing the press plate 71. The wall surface 88 is a surface parallel or substantially parallel to the Y axis and the Z axis. The wall surface 88 slides on the wall portion 71a of the press plate 71 when the flap 80 pivots around the shaft 73.

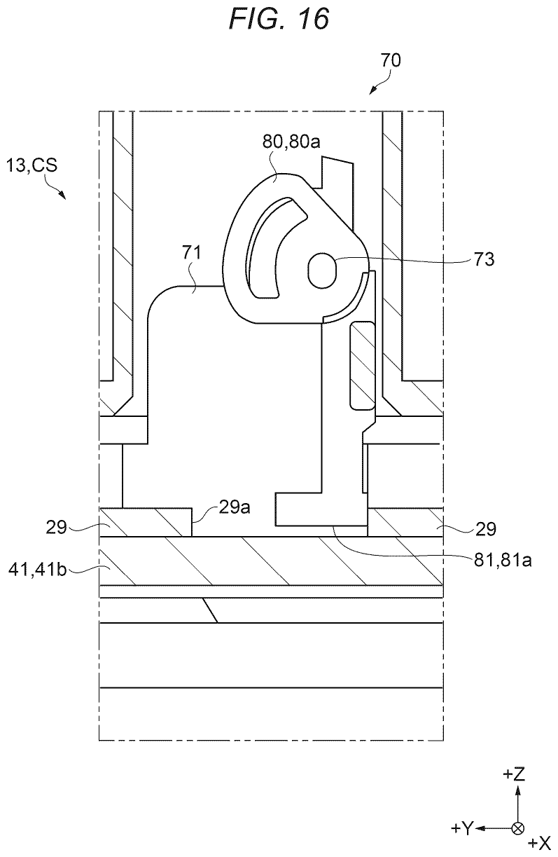

FIG. 16 illustrates a state of the detected portion 70. FIG. 16 illustrates the state of the detected portion 70 having the first flap 80a. FIG. 16 illustrates a posture of the flap 80 when the scanner housing 13 is in the shielded state CS.

When the scanner housing 13 is in the shielded state CS, the first lower surface 81a of the first flap 80a stops at a position in the −Z direction. The first lower surface 81a stops at a position facing the second glass 41b via the pressing plate opening 29a of the pressing plate 29. When the scanner housing 13 is in the shielded state CS, the first lower surface 81a stops at a position detectable by the second sensor module 35. A facing position of the first flap 80a facing the second sensor module 35 is the first lower surface 81a.

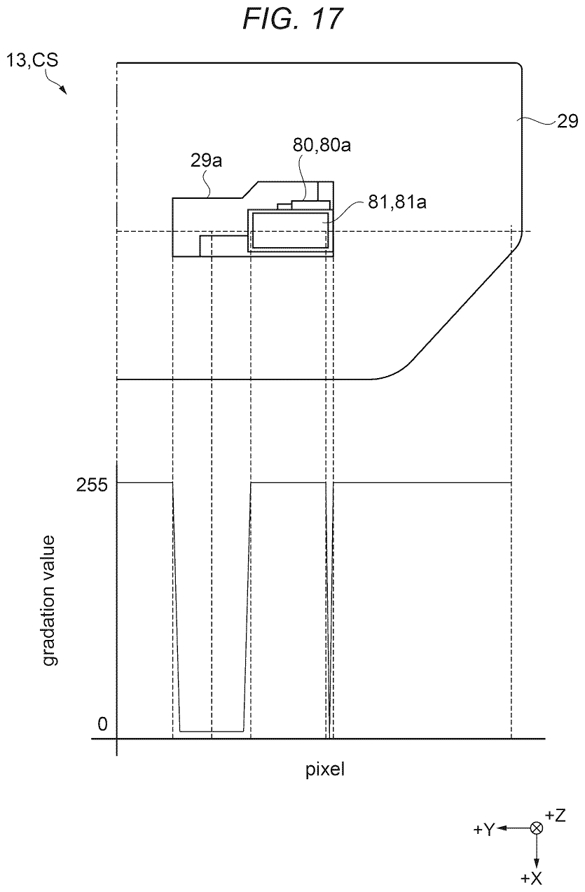

FIG. 17 illustrates a relationship between the state of the flap 80 and a detection pattern. FIG. 17 illustrates a vicinity of the pressing plate opening 29a in a plan view from the −Z direction. FIG. 17 illustrates the detection pattern associated with a position of the pressing plate 29 along the Y axis. The detection pattern is a detection result by the second sensor module 35. The second sensor module 35 faces the first flap 80a via the second glass 41b. FIG. 17 illustrates the relationship between the flap 80 and the detection pattern when the first flap 80a is in the state illustrated in FIG. 16.

When the scanner housing 13 is in the shielded state CS, the first lower surface 81a of the first flap 80a stops at a position facing the pressing plate opening 29a. The first lower surface 81a is detected by the second sensor module 35. The first lower surface 81a is formed in white. When the first lower surface 81a is detected by the second sensor module 35, the gradation value when the first lower surface 81a is detected is 255 or a value approximate to 255. As illustrated in FIG. 17, no member is disposed around the first lower surface 81a. The gradation value when a periphery of the first lower surface 81a is detected is 0 or a value approximate to 0. A detection pattern when the scanner housing 13 is in the shielded state CS is the pattern illustrated in FIG. 17.

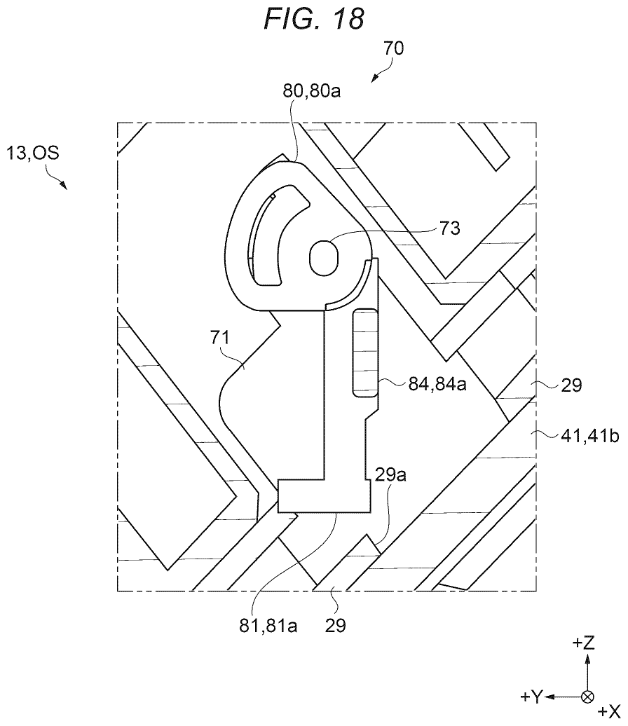

FIG. 18 illustrates a state of the detected portion 70. FIG. 18 illustrates the state of the detected portion 70 having the first flap 80a. FIG. 18 illustrates a posture of the flap 80 when the scanner housing 13 is in the open state OS.

When the scanner housing 13 is in the open state OS, the first flap 80a pivots with respect to the press plate 71 according to pivoting of the scanner housing 13. A pivoting posture of the first flap 80a changes with respect to the press plate 71 according to pivoting of the scanner housing 13. The first lower surface 81a of the first flap 80a continues to face the position in the −Z direction when the first flap 80a pivots. The position of the first lower surface 81a is displaced to a position different from the position facing the pressing plate opening 29a of the pressing plate 29. By the pivoting of the first flap 80a, the first side surface 84a is displaced to a position facing the pressing plate opening 29a. When the scanner housing 13 is in the open state OS, the first lower surface 81a is displaced to a position undetectable by the second sensor module 35. When the scanner housing 13 is in the open state OS, the first side surface 84a is displaced to a position detectable by the second sensor module 35. The facing position of the first flap 80a facing the second sensor module 35 changes from the first lower surface 81a to the first side surface 84a.

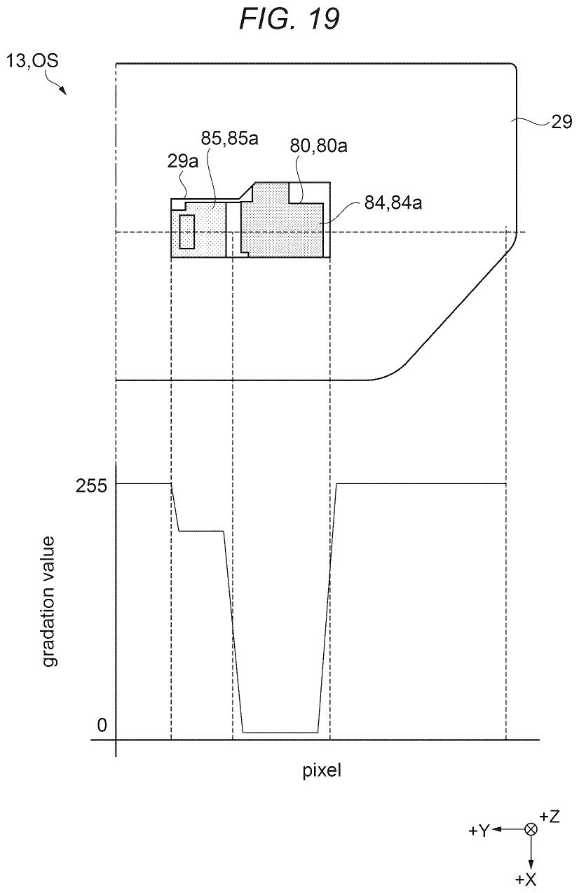

FIG. 19 illustrates a relationship between a state of the flap 80 and a detection pattern. FIG. 19 illustrates a vicinity of the pressing plate opening 29a in a plan view from the −Z direction. FIG. 19 illustrates the detection pattern associated with a position of the pressing plate 29 along the Y axis. The detection pattern is a detection result by the second sensor module 35. The second sensor module 35 faces the first flap 80a via the second glass 41b. FIG. 19 illustrates the relationship between the flap 80 and the detection pattern when the first flap 80a is in the state illustrated in FIG. 18.

When the scanner housing 13 is in the open state OS, the first side surface 84a of the first flap 80a stops at a position facing the pressing plate opening 29a. The first side surface 84a is detected by the second sensor module 35. The first side surface 84a is formed in black. When the first side surface 84a is detected by the second sensor module 35, the gradation value when the first side surface 84 a is detected is 0 or a value approximate to 0. As illustrated in FIG. 19, the first intermediate surface 85a is located at a position in a +Y direction of the first side surface 84a by the pivoting of the first flap 80a. The first intermediate surface 85a is formed in gray. The gradation value when a periphery of the first intermediate surface 85 a is detected is a value between 0 and 255. A detection pattern when the scanner housing 13 is in the open state OS is the pattern illustrated in FIG. 19.

When the scanner housing 13 changes from the open state OS to the shielded state CS, the first flap 80a is displaced from the posture illustrated in FIG. 18 to the posture illustrated in FIG. 16. The facing position of the first flap 80a facing the pressing plate opening 29a is displaced from the first side surface 84a to the first lower surface 81a. The facing position of the first flap 80a detected by the second sensor module 35 is displaced according to a pivoting state of the scanner housing 13.

As illustrated in FIGS. 17 and 19, the detection pattern when the scanner housing 13 is in the shielded state CS is different from the detection pattern when the scanner housing 13 is in the open state OS. The multifunction peripheral 10 can detect whether the scanner housing 13 is in the shielded state CS or the open state OS based on the detection pattern.

FIGS. 17 and 19 illustrate the detection pattern when the first flap 80a in which the first lower surface 81a is white and the first side surface 84a is black is used. When the flap 80 in which the lower surface 81 is black and the side surface 84 is white is used, the detection pattern when the scanner housing 13 is in the shielded state CS is different from the detection pattern when the scanner housing 13 is in the open state OS. When the color of the lower surface 81 and the color of the side surface 84 of the flap 80 are different, the detection pattern when the scanner housing 13 is in the shielded state CS is different from the detection pattern when the scanner housing 13 is in the open state OS.

The color of the first lower surface 81a may be white and the color of the first side surface 84a may be black, or the color of the first lower surface 81a may be black and the color of the first side surface 84a may be white. It is preferable that either the first lower surface 81a or the first side surface 84a is black. Since one of the first lower surface 81a and the first side surface 84a is black, a difference between the detection pattern when the scanner housing 13 is in the shielded state CS and the detection pattern when the scanner housing 13 is in the open state OS becomes large. The multifunction peripheral 10 can easily determine whether the scanner housing 13 is in the shielded state CS or the open state OS.

The first flap 80a is pivotable, and the facing position of the first flap 80a changes to the first lower surface 81a or the first side surface 84a according to the pivoting posture of the first flap 80a.

By changing the facing position to the first lower surface 81a or the first side surface 84a, it is possible to change the detection pattern detected by the second sensor module 35.

It is preferable that the second sensor module 35 faces the first lower surface 81a when the scanner housing 13 is in the shielded state CS, faces the first side surface 84a when the scanner housing 13 is in the open state OS, and the first color or the second color is black.

The multifunction peripheral 10 can easily determine whether the scanner housing 13 is in the shielded state CS or the open state OS.

The scanner housing 13 includes the document conveyance roller 27 that conveys the document D toward the second sensor module 35 along the document conveyance path 26, the ADF housing 13a that accommodates the document conveyance roller 27 and the flap 80, and the second glass 41b that faces the flap 80 across the document conveyance path 26. The second sensor module 35 preferably faces the flap 80 via the second glass 41b.

The second sensor module 35 stops at a position facing the pressing plate 29 and can detect the detection pattern at a position facing the pressing plate 29. The second sensor module 35 easily detects the flap 80 provided at a position of the pressing plate opening 29a of the pressing plate 29.

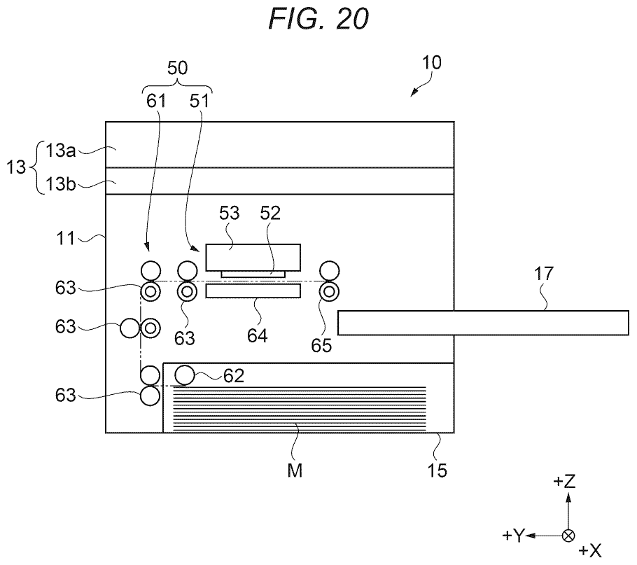

FIG. 20 illustrates a schematic configuration of the multifunction peripheral 10. FIG. 20 illustrates a YZ cross section of the multifunction peripheral 10. FIG. 20 illustrates an internal configuration of the printer housing 11. The printer housing 11 accommodates the printing mechanism 50.

The printing mechanism 50 performs printing on the medium M. The printing mechanism 50 conveys the medium M to a predetermined position and performs printing on the conveyed medium M. The printing mechanism 50 corresponds to an example of a printing unit. The printing mechanism 50 is controlled by the control unit 100 described later. The printing mechanism 50 includes a recording unit 51 and a medium conveyance unit 61.

The recording unit 51 performs printing on the medium M. The recording unit 51 illustrated in FIG. 20 performs printing by ejecting ink onto the medium M. The recording unit 51 may be an inkjet type that ejects ink onto the medium M, or may be an electrophotographic type. The recording unit 51 is preferably an inkjet type. The recording unit 51 includes a print head 52 and a carriage 53.

The print head 52 ejects ink toward the medium M. The print head 52 prints an image on the medium M by ejecting ink toward the medium M. The print head 52 has a plurality of nozzles on a surface facing the medium M. The ink is ejected from the plurality of nozzles. The print head 52 ejects ink of one or more colors onto the medium M.

The carriage 53 movably supports the print head 52. The carriage 53 moves the print head 52 in the +X direction or the −X direction along the X axis. The print head 52 ejects ink onto the medium M when moving along the X axis.

The medium conveyance unit 61 conveys the medium M from the paper feed cassette 15 toward the medium discharge tray 17. The medium conveyance unit 61 may convey the medium M supported by the paper feed tray 16 toward the medium discharge tray 17. In FIG. 20, the paper feed tray 16 and a medium conveyance path for conveying the medium M from the paper feed tray 16 toward the print head 52 are omitted. The medium conveyance unit 61 includes a pickup roller 62, a plurality of conveyance roller pairs 63, a platen 64, and a paper discharge roller pair 65.

The pickup roller 62 picks up the medium M placed on the paper feed cassette 15 and guides the medium M to the medium conveyance path. The pickup roller 62 is disposed at a position in the +Z direction of the paper feed cassette 15. The pickup roller 62 is pivotable about a pickup roller pivoting shaft (not illustrated) as a fulcrum.

The plurality of conveyance roller pairs 63 convey the medium M picked up by the pickup roller 62 to a position facing the print head 52. The plurality of conveyance roller pairs 63 are disposed along the medium conveyance path. The medium conveyance unit 61 illustrated in FIG. 20 includes four conveyance roller pairs 63, but is not limited thereto. The number of conveyance roller pairs 63 is appropriately set.

The platen 64 supports the medium M conveyed by the conveyance roller pair 63. The platen 64 is provided at a position facing the print head 52. The platen 64 supports the medium M at a predetermined interval with respect to the print head 52. The platen 64 supports the medium M onto which ink is ejected by the print head 52.

The paper discharge roller pair 65 conveys the medium M printed by the print head 52 toward the medium discharge tray 17. The medium M conveyed by the paper discharge roller pair 65 is placed on the medium discharge tray 17.

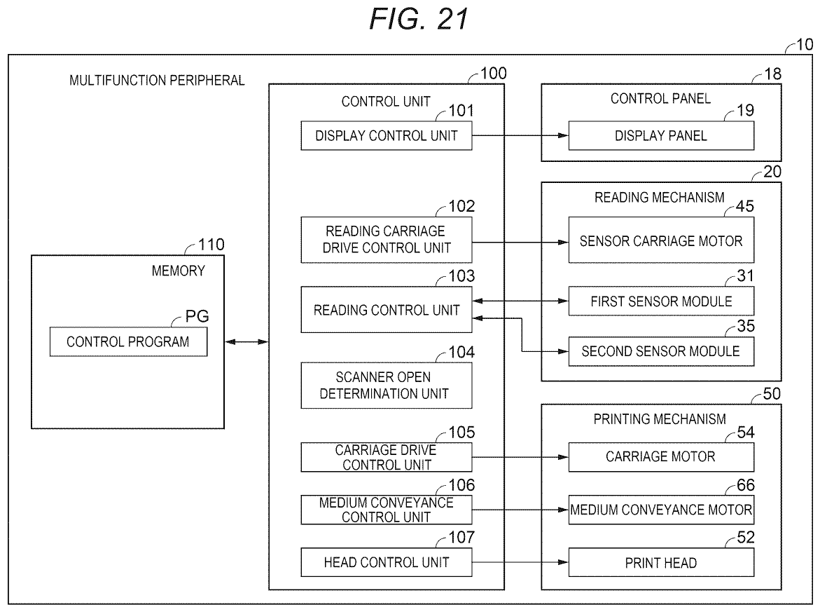

FIG. 21 illustrates a block configuration of the multifunction peripheral 10. The multifunction peripheral 10 includes the control panel 18, the reading mechanism 20, the printing mechanism 50, the control unit 100, and a memory 110.

The reading mechanism 20 includes a sensor carriage motor 45. The sensor carriage motor 45 is a driving source that generates a driving force for moving the sensor carriage 36. When the sensor carriage motor 45 is driven, the sensor carriage 36 moves along the X axis.

The printing mechanism 50 includes a carriage motor 54 and a medium conveyance motor 66. The carriage motor 54 is a driving source that generates a driving force for moving the carriage 53. The medium conveyance motor 66 is coupled to the conveyance roller pair 63 and the paper discharge roller pair 65 via a drive wheel train (not illustrated). The medium conveyance motor 66 is a driving source that generates a driving force for driving the conveyance roller pair 63 and the paper discharge roller pair 65.

The control unit 100 is a control controller that controls the reading mechanism 20, the printing mechanism 50, and the like. The control unit 100 corresponds to an example of a control unit. The control unit 100 is, as an example, a processor including a central processing unit (CPU). The control unit 100 is implemented with one or more processors. The control unit 100 functions as various functional units by executing a control program PG. The control unit 100 functions as a display control unit 101, a reading carriage drive control unit 102, a reading control unit 103, a scanner open determination unit 104, a carriage drive control unit 105, a medium conveyance control unit 106, and a head control unit 107.

The display control unit 101 controls display by the display panel 19. The display control unit 101 displays a menu screen, various notification screens, a notification message, and the like on the display panel 19. The display panel 19 displays various images such as a menu screen under control of the display control unit 101.

The reading carriage drive control unit 102 controls driving of the sensor carriage motor 45. The reading carriage drive control unit 102 moves the sensor carriage 36 by controlling the drive of the sensor carriage motor 45. The reading carriage drive control unit 102 moves the sensor carriage 36 to move the second sensor module 35 to the home position HP, a facing position facing the second glass 41b, and the like. The reading carriage drive control unit 102 moves the second sensor module 35 in the first reading area SA1. The second sensor module 35 moving in the first reading area SA1 reads the document D placed on the first glass 41a.

The reading control unit 103 controls the first sensor module 31 and the second sensor module 35. The reading control unit 103 causes the first sensor module 31 and the second sensor module 35 to read the document D conveyed in the document conveyance path 26. The reading control unit 103 causes the second sensor module 35 to read the document D placed on the first glass 41a. The reading control unit 103 generates read data by causing the first sensor module 31 and the second sensor module 35 to read the document D.

The reading control unit 103 causes the second sensor module 35 to read the pressing plate 29 and generate a detection pattern. The reading control unit 103 causes the second sensor module 35 to read the flap 80 disposed at the pressing plate opening 29a of the pressing plate 29 and generate a detection pattern. The reading control unit 103 transmits the detection pattern generated by the second sensor module 35 to the scanner open determination unit 104.

The reading control unit 103 causes the second sensor module 35 to read the guide member 43 and generate a detection pattern. The reading control unit 103 transmits the detection pattern generated when the second sensor module 35 reads the guide member 43 to the scanner open determination unit 104.

The scanner open determination unit 104 receives the detection pattern generated by the second sensor module 35. The scanner open determination unit 104 detects the shielded state CS of the scanner housing 13 with respect to the printer housing 11 or the open state OS of the scanner housing 13 with respect to the printer housing 11 based on the detection pattern. The detection pattern corresponds to an example of a reading result.

As an example, the scanner open determination unit 104 receives the detection pattern illustrated in FIG. 17 from the reading control unit 103. The scanner open determination unit 104 determines the detection pattern illustrated in FIG. 17. The scanner open determination unit 104 determines that the scanner housing 13 is in the shielded state CS with respect to the printer housing 11 based on a determination result. The scanner open determination unit 104 detects the shielded state CS of the scanner housing 13 with respect to the printer housing 11.

The scanner open determination unit 104 receives the detection pattern illustrated in FIG. 19 from the reading control unit 103. The scanner open determination unit 104 determines the detection pattern illustrated in FIG. 19. The scanner open determination unit 104 determines that the scanner housing 13 is in the open state OS with respect to the printer housing 11 based on a determination result. The scanner open determination unit 104 detects the open state OS of the scanner housing 13 with respect to the printer housing 11.

The scanner open determination unit 104 receives the detection pattern illustrated in FIG. 11 or 12 from the reading control unit 103. The scanner open determination unit 104 determines the detection pattern illustrated in FIG. 11 or 12. The scanner open determination unit 104 determines whether the second sensor module 35 is stopped at the home position HP based on a determination result. The scanner open determination unit 104 can detect a stop position of the second sensor module 35 based on the detection pattern.

When it is determined that the scanner housing 13 is in the open state OS with respect to the printer housing 11, the scanner open determination unit 104 transmits a stop signal to the carriage drive control unit 105, the medium conveyance control unit 106, and the head control unit 107. The scanner open determination unit 104 stops the printing mechanism 50 by transmitting a stop signal to the carriage drive control unit 105 and the like. By stopping the printing mechanism 50 based on the stop signal, a possibility of contact by a user with the printing mechanism 50 during driving is reduced. It is possible to prevent the user from damaging the printing mechanism 50.

The carriage drive control unit 105 controls driving of the carriage motor 54. The carriage drive control unit 105 moves the carriage 53 by controlling the driving of the carriage motor 54. The carriage drive control unit 105 moves the print head 52 along the X axis by moving the carriage 53. Upon receiving the stop signal, the carriage drive control unit 105 immediately stops the carriage motor 54. When receiving the stop signal, the carriage drive control unit 105 may move the carriage 53 to a predetermined stop position and then stop the driving of the carriage motor 54.

The medium conveyance control unit 106 controls driving of the medium conveyance motor 66. The medium conveyance control unit 106 controls conveyance of the medium M by controlling driving of the medium conveyance motor 66. The medium conveyance control unit 106 conveys the medium M from the paper feed cassette 15 or the paper feed tray 16 toward the medium discharge tray 17. Upon receiving the stop signal, the medium conveyance control unit 106 stops the medium conveyance motor 66. When receiving the stop signal, the medium conveyance control unit 106 stops the conveyance of the medium M.

The head control unit 107 controls ejection of ink by the print head 52. The head control unit 107 receives read data and the like. The head control unit 107 causes the print head 52 to eject ink based on the read data and the like. The head control unit 107 causes the print head 52 to perform printing by causing the print head 52 to eject ink. Upon receiving the stop signal, the head control unit 107 stops control of the print head 52 by the head control unit 107. Upon receiving the stop signal, the head control unit 107 stops printing by the print head 52.

The memory 110 stores various information, programs, and the like. The memory 110 stores the control program PG that causes the control unit 100 to operate as various functional units. The memory 110 may store reference pattern information used when the scanner open determination unit 104 determines the detection pattern. The scanner open determination unit 104 determines the detection pattern transmitted from the second sensor module 35 using the reference pattern information. The memory 110 may store various images displayed on the display panel 19. The memory 110 includes a semiconductor memory such as a read only memory (ROM) and a random access memory (RAM).

The control program PG is firmware that causes the control unit 100 to function as various functional units. The control program PG operates in the control unit 100. The control program PG may cause the control unit 100 to function as a functional unit other than the display control unit 101, the reading carriage drive control unit 102, the reading control unit 103, the scanner open determination unit 104, the carriage drive control unit 105, the medium conveyance control unit 106, and the head control unit 107.

The multifunction peripheral 10 includes the printing mechanism 50 that performs printing on the medium M, the printer housing 11 that accommodates the printing mechanism 50, the scanner housing 13 that includes the second sensor module 35 that reads the document D and is pivotable between the shielded state CS in which the printer housing 11 is closed and the open state OS in which the printer housing 11 is opened, and the control unit 100 that controls the printing mechanism 50 and the second sensor module 35. The scanner housing 13 includes the flap 80 that includes the lower surface 81 having the first color and the side surface 84 having the second color different from the first color and has a facing position facing the second sensor module 35 different between when the scanner housing 13 is in the open state OS and when the scanner housing 13 is in the shielded state CS. The control unit 100 detects the open state OS of the scanner housing 13 or the shielded state CS of the scanner housing 13 with respect to the printer housing 11 based on the detection pattern of the flap 80 by the second sensor module 35.

The multifunction peripheral 10 can detect the open state OS or the shielded state CS of the scanner housing 13 without including a dedicated open/close sensor that detects opening and closing of the scanner housing 13. It is possible to provide the multifunction peripheral 10 in which the number of components is reduced.

The control unit 100 preferably stops the printing mechanism 50 when detecting the open state OS of the scanner housing 13 with respect to the printer housing 11 based on the detection pattern of the flap 80 by the second sensor module 35 during an operation of the printing mechanism 50.

By stopping the printing mechanism 50, the possibility of contact by the user with the printing mechanism 50 during driving is reduced.

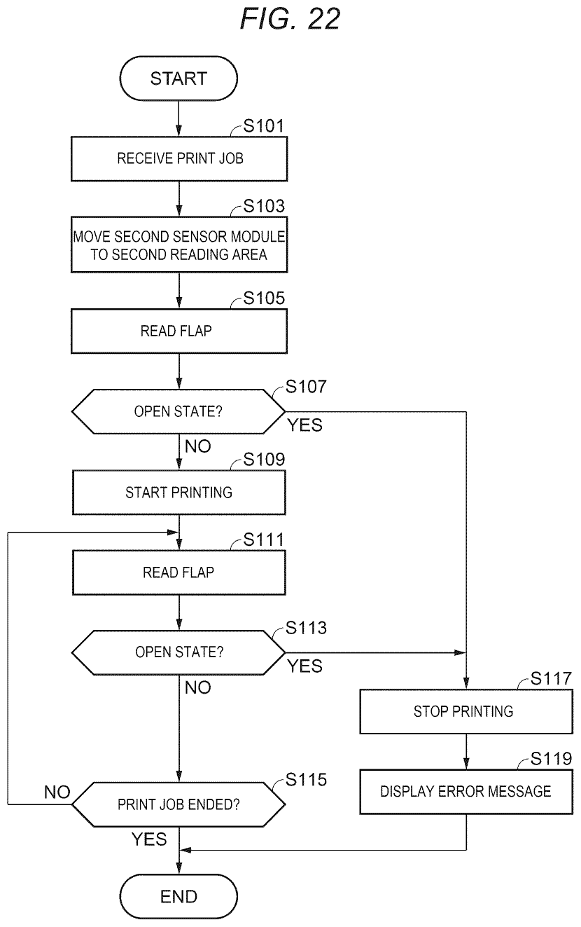

FIG. 22 illustrates a control flow executed by the multifunction peripheral 10. FIG. 22 is a flowchart illustrating the control flow. The control flow corresponds to an example of a control method. FIG. 22 illustrates the control flow when the printing mechanism 50 performs printing on the medium M. FIG. 22 illustrates the control flow executed by the control program PG causing the control unit 100 to function as each functional unit.

In step S101, the multifunction peripheral 10 receives a print job. The multifunction peripheral 10 receives the print job for instructing printing from an external device connected for communication and receives the print job. The print job corresponds to an example of a printing instruction. The control unit 100 of the multifunction peripheral 10 acquires the print job.

Upon receiving the print job, the multifunction peripheral 10 moves the second sensor module 35 to the second reading area SA2 in step S103. Upon receiving the print job, the multifunction peripheral 10 moves the second sensor module 35 from the home position HP to the second reading area SA2. The reading carriage drive control unit 102 controls the sensor carriage motor 45 to move the sensor carriage 36 to the second reading area SA2. In the second reading area SA2, the second sensor module 35 faces the pressing plate 29. The pressing plate 29 is provided with the pressing plate opening 29a. The flap 80 is disposed at the position of the pressing plate opening 29a.

After moving the second sensor module 35 to the second reading area SA2, the multifunction peripheral 10 reads the flap 80 in step S105. The second sensor module 35 reads the flap 80 and the pressing plate 29 and generates a detection pattern. The second sensor module 35 transmits the detection pattern to the scanner open determination unit 104. The scanner open determination unit 104 receives the detection pattern.

After reading the flap 80, the multifunction peripheral 10 determines whether the scanner housing 13 is in the open state OS in step S107. The scanner open determination unit 104 determines whether the scanner housing 13 is in the open state OS with respect to the printer housing 11 based on the detection pattern. When the scanner open determination unit 104 determines that the scanner housing 13 is not in the open state OS with respect to the printer housing 11, the multifunction peripheral 10 proceeds to step S109 (step S107: NO). When the scanner open determination unit 104 determines that the scanner housing 13 is in the open state OS with respect to the printer housing 11, the multifunction peripheral 10 proceeds to step S117 (step S107: YES).

When it is determined that the scanner housing 13 is not in the open state OS with respect to the printer housing 11, the multifunction peripheral 10 starts printing in step S109. The control unit 100 operates the printing mechanism 50 to start printing on the medium M. The printing mechanism 50 starts printing under control of the control unit 100.

After starting printing, the multifunction peripheral 10 reads the flap 80 in step S111. The second sensor module 35 reads the flap 80 at a predetermined timing. The predetermined timing is set in advance. The second sensor module 35 reads the flap 80 and the pressing plate 29 and generates a detection pattern. The second sensor module 35 transmits the detection pattern to the scanner open determination unit 104. The scanner open determination unit 104 receives the detection pattern.

After reading the flap 80, the multifunction peripheral 10 determines whether the scanner housing 13 is in the open state OS in step S113. During the printing operation, the multifunction peripheral 10 causes the scanner open determination unit 104 to monitor whether the scanner housing 13 is in the open state OS with respect to the printer housing 11. The scanner open determination unit 104 determines whether the scanner housing 13 is in the open state OS with respect to the printer housing 11 based on the detection pattern. When the scanner open determination unit 104 determines that the scanner housing 13 is not in the open state OS with respect to the printer housing 11, the multifunction peripheral 10 proceeds to step S115 (step S113: NO). When it is determined that the scanner housing 13 is in the open state OS with respect to the printer housing 11, the scanner open determination unit 104 determines that the scanner housing 13 is opened by a user during the execution of the printing operation. The multifunction peripheral 10 proceeds to step S117 (step S113: YES).

In step S115, the multifunction peripheral 10 determines whether the print job is ended. When it is determined that the print job is ended, the multifunction peripheral 10 ends the operation (step S115: YES). When it is determined that the print job is not ended, the multifunction peripheral 10 returns to step S111 (step S115: NO).

In step S117, the multifunction peripheral 10 stops printing. When it is determined that the scanner housing 13 is in the open state OS with respect to the printer housing 11, the scanner open determination unit 104 transmits a stop signal to the carriage drive control unit 105, the medium conveyance control unit 106, and the head control unit 107. When receiving the stop signal, the carriage drive control unit 105 and the like stops the carriage motor 54 and the like. The multifunction peripheral 10 stops the printing mechanism 50 based on the stop signal. When it is determined that the scanner housing 13 is in the open state OS with respect to the printer housing 11 before starting printing, the scanner open determination unit 104 does not start printing. When it is determined that the scanner housing 13 is in the open state OS with respect to the printer housing 11 during the printing operation, the scanner open determination unit 104 stops the printing.

After stopping the printing, the multifunction peripheral 10 displays an error message 120 in step S119. When detecting that the scanner housing 13 is in the open state OS with respect to the printer housing 11, the multifunction peripheral 10 displays the error message 120 on the display panel 19. As an example, the error message 120 indicates that the printing is stopped. The display of the error message 120 corresponds to an example of a notification.

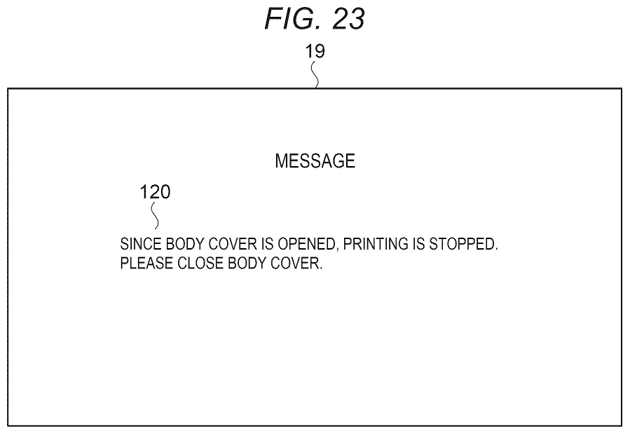

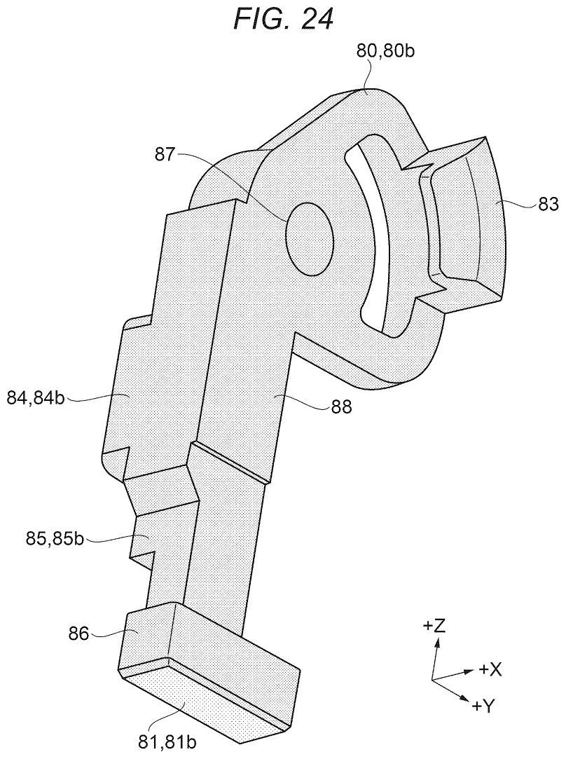

FIG. 23 illustrates a display example displayed on the display panel 19. FIG. 23 illustrates the display panel 19 that displays the error message 120. The error message 120 indicates that the scanner housing 13 is in the open state OS with respect to the printer housing 11 and that printing is stopped. The error message 120 represents the scanner housing 13 as a body cover. The user can recognize that the printing is stopped by visually recognizing the error message 120.

FIG. 23 illustrates an example in which the error message 120 is displayed on the display panel 19, but the present disclosure is not limited thereto. An audio output unit (not illustrated) may output the error message 120. The audio output unit outputs audio corresponding to the error message 120. A content of the error message 120 is appropriately set.

As illustrated in FIG. 22, after displaying the error message 120, the multifunction peripheral 10 ends the control flow. After displaying the error message 120, the multifunction peripheral 10 may monitor whether the scanner housing 13 changes to the shielded state CS with respect to the printer housing 11. When the scanner open determination unit 104 determines that the scanner housing 13 is in the shielded state CS with respect to the printer housing 11, the processing may proceed to step S115. The multifunction peripheral 10 continues the control flow.

The control flow is executed in the multifunction peripheral 10 including the printer housing 11 accommodating the printing mechanism 50 that performs printing on the medium M, and the scanner housing 13 that includes the flap 80 including the lower surface 81 having the first color and the side surface 84 having the second color different from the first color, and the second sensor module 35, and is pivotable between the shielded state CS in which the printer housing 11 is closed and the open state OS in which the printer housing 11 is opened. The control flow includes: receiving a print job instructing printing on the medium M; starting printing on the medium M; and monitoring whether the scanner housing 13 is in the open state OS with respect to the printer housing 11 based on the detection pattern of the flap 80 by the second sensor module 35 when the printing is performed.

The multifunction peripheral 10 can monitor whether the scanner housing 13 is in the open state OS with respect to the printer housing 11 based on the detection pattern.

It is preferable that the control flow stops printing when it is detected that the scanner housing 13 is in the open state OS with respect to the printer housing 11.

A possibility of the user coming into contact with the printing mechanism 50 during driving is reduced.

It is preferable to include displaying the error message 120 indicating that the printing is stopped when it is detected that the scanner housing 13 is in the open state OS with respect to the printer housing 11.

The user can confirm that the printing is stopped.

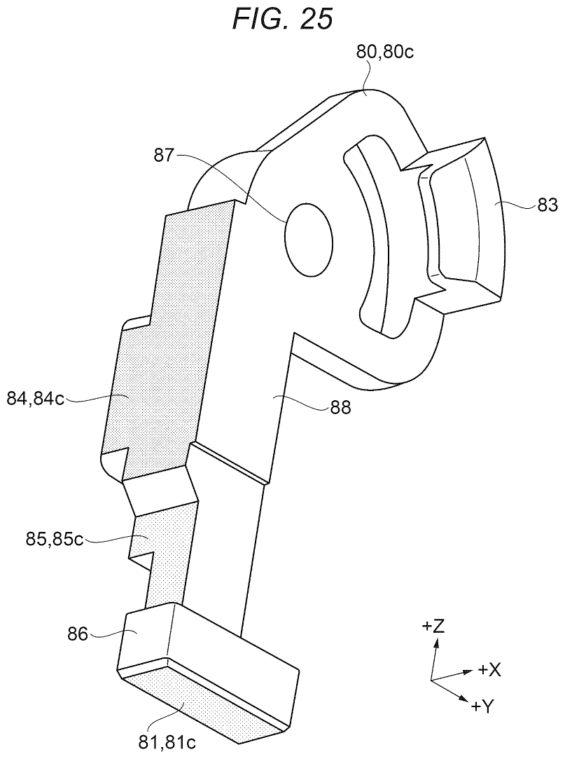

FIGS. 24, 25, 26, 27, and 28 illustrate a schematic configuration of the flap 80. FIGS. 24, 25, 26, 27, and 28 are perspective views illustrating the flap 80. The flap 80 has the lower surface 81, the hook 83, the side surface 84, the intermediate surface 85, the abutment surface 86, the through hole 87, and the wall surface 88.

FIG. 24 illustrates a configuration of a second flap 80b which is an example of the flap 80. The second flap 80b has a second lower surface 81b, a second side surface 84b, and a second intermediate surface 85b. The second lower surface 81b, the second side surface 84b, and the second intermediate surface 85b are examples of the lower surface 81, the side surface 84, and the intermediate surface 85, respectively.

The second lower surface 81b is formed in gray. The second side surface 84b is formed in black. The second intermediate surface 85b is formed in black. A color of the second lower surface 81b is different from a color of the second side surface 84b. When the second flap 80b is used for the detected portion 70, a detection pattern when the scanner housing 13 is in the shielded state CS with respect to the printer housing 11 is different from a detection pattern when the scanner housing 13 is in the open state OS with respect to the printer housing 11. The scanner open determination unit 104 can detect whether the scanner housing 13 is in the shielded state CS or the open state OS.

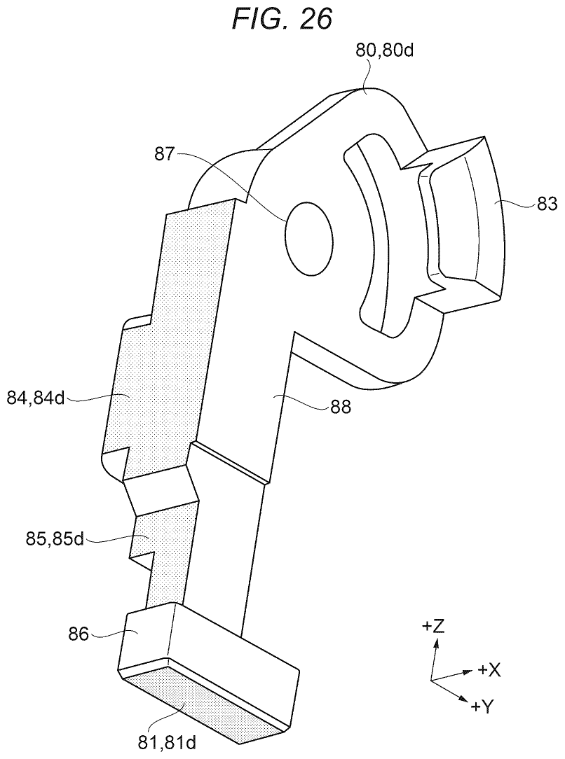

FIG. 25 illustrates a configuration of a third flap 80c which is an example of the flap 80. The third flap 80c has a third lower surface 81c, a third side surface 84c, and a third intermediate surface 85c. The third lower surface 81c, the third side surface 84c, and the third intermediate surface 85c are examples of the lower surface 81, the side surface 84, and the intermediate surface 85, respectively.

The third lower surface 81c is formed in gray. The third side surface 84c is formed in black. The third intermediate surface 85c is formed in gray. A color of the third lower surface 81c is different from a color of the third side surface 84c. When the third flap 80c is used for the detected portion 70, a detection pattern when the scanner housing 13 is in the shielded state CS with respect to the printer housing 11 is different from a detection pattern when the scanner housing 13 is in the open state OS with respect to the printer housing 11. The scanner open determination unit 104 can detect whether the scanner housing 13 is in the shielded state CS or the open state OS.

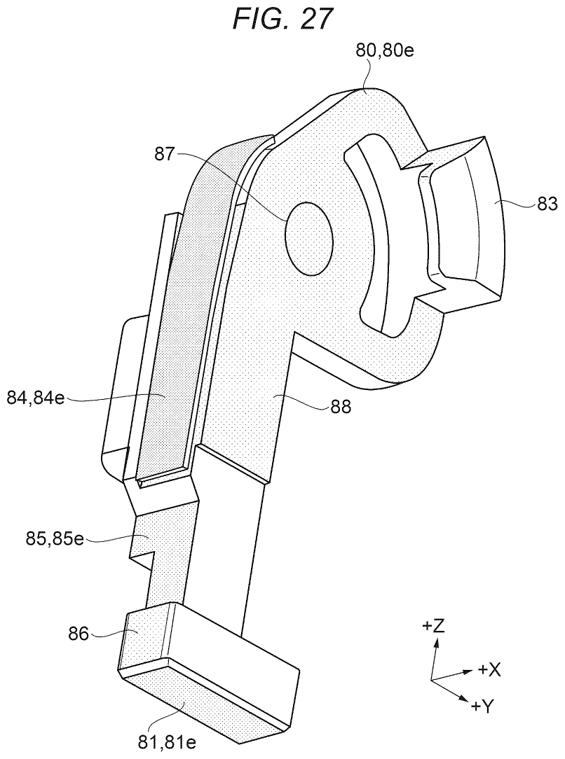

FIG. 26 illustrates a configuration of a fourth flap 80d which is an example of the flap 80. The fourth flap 80d has a fourth lower surface 81d, a fourth side surface 84d, and a fourth intermediate surface 85d. The fourth lower surface 81d, the fourth side surface 84d, and the fourth intermediate surface 85d are examples of the lower surface 81, the side surface 84, and the intermediate surface 85, respectively.

The fourth lower surface 81d is formed in black. The fourth side surface 84d is formed in gray. The fourth intermediate surface 85d is formed in gray. A color of the fourth lower surface 81d is different from a color of the fourth side surface 84d. When the fourth flap 80d is used for the detected portion 70, a detection pattern when the scanner housing 13 is in the shielded state CS with respect to the printer housing 11 is different from a detection pattern when the scanner housing 13 is in the open state OS with respect to the printer housing 11. The scanner open determination unit 104 can detect whether the scanner housing 13 is in the shielded state CS or the open state OS.

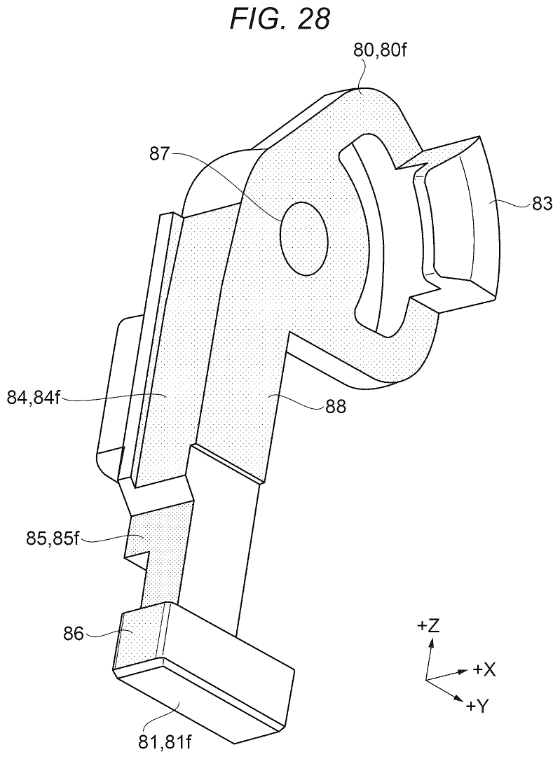

FIG. 27 illustrates a configuration of a fifth flap 80e which is an example of the flap 80. The fifth flap 80e has a fifth lower surface 81e, a fifth side surface 84e, and a fifth intermediate surface 85e. The fifth lower surface 81e, the fifth side surface 84e, and the fifth intermediate surface 85e are examples of the lower surface 81, the side surface 84, and the intermediate surface 85, respectively.

The fifth lower surface 81e is formed in gray. The fifth side surface 84e is formed in black. The fifth intermediate surface 85e is formed in gray. A color of the fifth lower surface 81e is different from a color of the fifth side surface 84e. When the fifth flap 80e is used for the detected portion 70, a detection pattern when the scanner housing 13 is in the shielded state CS with respect to the printer housing 11 is different from a detection pattern when the scanner housing 13 is in the open state OS with respect to the printer housing 11. The scanner open determination unit 104 can detect whether the scanner housing 13 is in the shielded state CS or the open state OS.

FIG. 28 illustrates a configuration of a sixth flap 80f which is an example of the flap 80. The sixth flap 80f has a sixth lower surface 81f, a sixth side surface 84f, and a sixth intermediate surface 85f. The sixth lower surface 81f, the sixth side surface 84f, and the sixth intermediate surface 85f are examples of the lower surface 81, the side surface 84, and the intermediate surface 85, respectively.

The sixth lower surface 81f is formed in white. The sixth side surface 84f is formed in yellow. The sixth intermediate surface 85f is formed in gray. A color of the sixth lower surface 81f is different from a color of the sixth side surface 84f. When the sixth flap 80f is used for the detected portion 70, a detection pattern when the scanner housing 13 is in the shielded state CS with respect to the printer housing 11 is different from a detection pattern when the scanner housing 13 is in the open state OS with respect to the printer housing 11. The scanner open determination unit 104 can detect whether the scanner housing 13 is in the shielded state CS or the open state OS.

What is claimed is:

1. A printing apparatus comprising:
a printing unit configured to perform printing on a medium;
a body case accommodating the printing unit;
a scanner unit that includes an image reading sensor for reading a document and that is pivotable between a closed state in which the body case is closed and an open state in which the body case is opened; and
a control unit configured to control the printing unit and the image reading sensor, wherein
the scanner unit includes a reading reference member that includes a first portion having a first color and a second portion having a second color different from the first color and that has a facing position facing the image reading sensor different between when the scanner unit is in the open state and when the scanner unit is in the closed state, and
the control unit detects the open state of the scanner unit or the closed state of the scanner unit with respect to the body case based on a reading result of the reading reference member by the image reading sensor.

2. The printing apparatus according to claim 1, wherein
the reading reference member is pivotable, and
the facing position of the reading reference member changes to the first portion or the second portion according to a pivoting posture of the reading reference member.

3. The printing apparatus according to claim 1, wherein
the image reading sensor faces the first portion when the scanner unit is in the closed state, and faces the second portion when the scanner unit is in the open state, and
the first color or the second color is black.

4. The printing apparatus according to claim 1, wherein
the scanner unit includes
a conveyance roller configured to convey the document toward the image reading sensor along a conveyance path,
a housing member configured to accommodate the conveyance roller and the reading reference member, and
a light transmissive member facing the reading reference member across the conveyance path, and
the image reading sensor faces the reading reference member via the light transmissive member.

5. The printing apparatus according to claim 1, wherein
the control unit stops the printing unit when the open state of the scanner unit with respect to the body case is detected based on the reading result of the reading reference member by the image reading sensor during an operation of the printing unit.

6. A control method for a printing apparatus including a body case accommodating a printing unit that performs printing on a medium, and a scanner unit that includes a reading reference member and an image reading sensor and that is pivotable between a closed state in which the body case is closed and an open state in which the body case is opened, the reading reference member including a first portion having a first color and a second portion having a second color different from the first color, the control method comprising:
receiving a printing instruction for instructing the printing on the medium;
starting the printing on the medium; and
monitoring whether the scanner unit is in the open state with respect to the body case based on a reading result of the reading reference member by the image reading sensor when the printing is performed.

7. The control method according to claim 6, further comprising:
stopping the printing when detecting that the scanner unit is in the open state with respect to the body case.

8. The control method according to claim 7, further comprising:
performing a notification indicating that the printing is stopped when detecting that the scanner unit is in the open state with respect to the body case.
